(19) United States
(12) Patent Application Publication
(10) Pub. No.: US 2010/0227948 A1
(43) Pub. Date: Sep. 9, 2010

(54) INK COMPOSITION FOR INKJET RECORDING

(75) Inventors: Makoto NAGASE, Shiojiri-shi (JP); Masahiro YATAKE, Shiojiri-shi (JP)

Correspondence Address: LADAS & PARRY LLP, 26 WEST 61ST STREET, NEW YORK, NY, 10023, US

(73) Assignee: SEIKO EPSON CORPORATION.

(21) Appl. No.: 12/691,051

(22) Filed: Jan. 21, 2010

(30) Foreign Application Priority Data
Jan. 22, 2009 (JP) 2009-011682
Jan. 22, 2009 (JP) 2009-011683
Jan. 5, 2010 (JP) 2010-000447
Jan. 5, 2010 (JP) 2010-000448

(51) Int. Cl. C08K 7/00

(52) U.S. Cl. 523/221; 977/773

(57) ABSTRACT

It is an object of the invention to provide an inkjet recording ink that is excellent in color-developing property, stability, and fixing property and is excellent, in particular, as an inkjet recording ink for textile.

The inkjet recording ink according to the invention contains a pigment dispersion that enables a pigment to be dispersed in water by using a polymer in which 50% by weight or more of benzyl acrylate and 15% by weight or less of methacrylic acid and/or acrylic acid are polymerized as constituents and that has an average particle size of 50 nm or more and 300 nm or less; polymer microparticles having a glass transition temperature of 0° C. or less and an acid number of 100 mg KOH/g or less; and fluorine resin particles having an average particle size of 400 nm or less.

### CROSS-REFERENCES TO RELATED APPLICATIONS

The entire disclosure of Japanese Patent Application No. 2009-011682, filed on Jan. 22, 2009, No. 2009-011683, filed on Jan. 22, 2009, No. 2010-000447, filed on Jan. 5, 2010, and No. 2010-000448, filed on Jan. 5, 2010 are expressly incorporated by reference herein.

### FIELD OF THE INVENTION

The present invention relates to an inkjet recording ink that is excellent in color-developing property, stability, and fixing property and is excellent, in particular, as an inkjet recording ink for textile.

### BACKGROUND OF THE INVENTION

Characteristics required in an ink used for inkjet recording are that, for example, no bleeding occurs in printing on paper serving as a recording medium, drying is rapid, uniform printing on surfaces of various recording media is possible, and mixing between adjacent colors does not occur in polychromatic printing such as color printing.

In known inks, particularly, in many of pigment-based inks, the securing of printing quality has been investigated and put into practical use by mainly suppressing the penetrating ability of an ink for suppressing the wetting of the ink to the surface of paper and for allowing ink droplets to stay near the surface of the paper. However, in an ink of which wetting to paper is suppressed, bleeding largely varies depending on a difference in type of paper, in particular, in recycled paper including components of various types of paper, the variation in wetting property of the ink to each of the components causes bleeding. In addition, such an ink has a problem that the printing takes a long time for drying, which causes color mixing between adjacent colors in polychromatic printing such as color printing. Furthermore, in an ink containing a pigment as a color material, since the pigment remains on the surface of paper or the like, it has a problem of a decrease in abrasion resistance.

In order to solve these problems, it has been attempted to increase penetrating ability of an ink to paper, and addition of diethylene glycol monobutyl ether (refer to Patent Document 1); addition of Surfynol 465 (manufactured by Nisshin Chemical Co., Ltd.), which is an acetylene glycol-based surfactant (refer to Patent Document 2); and addition of both diethylene glycol monobutyl ether and Surfynol 465 (refer to Patent Document 3) have been investigated. In addition, the use of a diethylene glycol ether in an ink has been investigated (refer to Patent Document 4).

Furthermore, in an ink containing a pigment, it is usually difficult to increase penetrating ability of the ink while securing dispersion stability of the pigment, and therefore the selection of available penetrants is restricted. As known combinations of a glycol ether and a pigment, for example, there are an example in which triethylene glycol monomethyl ether is used as a pigment (refer to Patent Document 5) and an example in which an ether, i.e., ethylene glycol, diethylene glycol, or triethylene glycol, is used (refer to Patent Document 6).

Furthermore, as inks for textile, there are, for example, those using a dye (refer to Patent Document 7) or relating to an adhesive (Patent Document 8).

### RELATED ART

[Patent Document 1] U.S. Pat. No. 5,156,675

[Patent Document 2] U.S. Pat. No. 5,183,502

[Patent Document 3] U.S. Pat. No. 5,196,056

[Patent Document 4] U.S. Pat. No. 2,083,372

[Patent Document 5] JP-A-56-147861

[Patent Document 6] JP-A-9-111165

[Patent Document 7] JP-T-2007-515561

[Patent Document 8] JP-A-2007-126635

### SUMMARY OF THE INVENTION

However, the known ink is insufficient in printing quality and is, in particular, as an inkjet recording ink for textile, insufficient in fixing property and also in color concentration and color-developing property. In addition, the known pigment dispersion is low in storage stability and therefore instable, and, in the presence of a material having a hydrophilic moiety and a hydrophobic moiety, such as a surfactant or a glycol ether, a polymer easily attaches to or detaches from the pigment. Thus, there has been a problem that the storage stability of the ink is inferior. In a common aqueous ink, a material having a hydrophilic moiety and a hydrophobic moiety, such as a surfactant or a glycol ether, is essential in order to reduce bleeding to paper. An ink not containing such a material is insufficient in penetrating ability to paper and, thereby, has problems that the type of paper is restricted for performing uniform printing and that a reduction in a printed image easily occurs.

Furthermore, if a known dispersion contains an additive (an acetylene glycol-based or acetylene alcohol-based surfactant, di(tri)ethylene glycol monobutyl ether, (di)propylene glycol monobutyl ether, 1,2-alkylene glycol, or a mixture thereof) that is used in the invention, long storage stability is not obtained, and redissolvability of the ink is poor. Therefore, the ink has a problem to easily cause clogging in, for example, the tip of a nozzle of an inkjet head by being dried.

Accordingly, the invention solves such problems, and it is an object thereof to provide an inkjet recording ink that is excellent in color-developing property, stability, and fixing property and is excellent, in particular, as an inkjet recording ink for textile, and is also excellent in discharge stability of the ink from an inkjet head.

An inkjet recording ink of a first embodiment of the invention contains a pigment dispersion that enables a pigment to be dispersed in water by using a polymer in which 50% by weight or more of benzyl acrylate and 15% by weight or less of methacrylic acid and/or acrylic acid are polymerized as constituents and that has an average particle size of 50 nm or more and 300 nm or less; and fluorine resin particles having an average particle size of 400 nm or less.

Furthermore, an inkjet recording ink of a second embodiment of the invention contains a pigment dispersion that enables a pigment to be dispersed in water by using a polymer in which 50% by weight or more of benzyl acrylate and 15% by weight or less of methacrylic acid and/or acrylic acid are polymerized as constituents and that has an average particle size of 50 nm or more and 300 nm or less; polymer microparticles having a glass transition temperature of 0° C. or less and an acid number of 100 mg KOH/g or less; and fluorine resin particles having an average particle size of 400 nm or less.

### DETAILED DESCRIPTION OF THE PRESENT INVENTION

The invention has been accomplished as a result of intensive studies considering the requirement for characteristics such as being excellent in color-developing property, stability, and fixing property and being excellent, in particular, as an inkjet recording ink for textile.

An inkjet recording ink of a first embodiment of the invention contains a pigment dispersion that enables a pigment to be dispersed in water by using a polymer in which 50% by weight or more of benzyl acrylate and 15% by weight or less of methacrylic acid and/or acrylic acid are polymerized as constituents and that has an average particle size of 50 nm or more and 300 nm or less; and fluorine resin particles having an average particle size of 400 nm or less.

An inkjet recording ink of a second embodiment of the invention contains a pigment dispersion that enables a pigment to be dispersed in water by using a polymer in which 50% by weight or more of benzyl acrylate and 15% by weight or less of methacrylic acid and/or acrylic acid are polymerized as constituents and that has an average particle size of 50 nm or more and 300 nm or less; polymer microparticles having a glass transition temperature of 0° C. or less and an acid number of 100 mg KOH/g or less; and fluorine resin particles having an average particle size of 400 nm or less.

The components contained in the inkjet recording ink (hereinafter referred to as ink) of the first embodiment or the second embodiment of the invention will be described below.

The average particle sizes of the pigment dispersion and the fluorine resin particles are measured by a light-scattering method. When the average particle size of the pigment dispersion measured by the light-scattering method is smaller than 50 nm, the color-developing property is decreased. In addition, when the average particle size of the pigment dispersion is larger than 300 nm, the fixing property is decreased. The average particle size is more preferably from 60 to 230 nm. The particle size of the fluorine resin particles is 400 nm or less and preferably 300 nm or less. When the particle size of the fluorine resin particles is larger than 400 nm, discharge from an inkjet head tends to be unstable.

The inks of the first embodiment and the second embodiment of the invention each contain fluorine resin particles. By adding the fluorine resin particles to the ink, the abrasion resistance, in particular, as an ink for textile is increased. The addition amount of the fluorine resin particles is preferably from 0.1 to 10% by weight. When the amount of the fluorine resin particles added to the ink is smaller than 0.1% by weight, the effect of improving the abrasion resistance is not sufficiently achieved, and when the amount is larger than 10% by weight, discharge from an inkjet head tends to be unstable. The addition amount of the fluorine resin particles based on the pigment weight is preferably from 10 to 150% by weight based on the pigment content. An addition amount of 10% by weight or more based on the pigment content can improve the abrasion resistance regardless of the type of the pigment, and an amount of 150% by weight or less does not impair the color concentration and the color-developing property and can maintain the discharge from an inkjet head in a stable state.

Examples of the fluorine resin used as the fluorine resin particles of the invention include polytetrafluoroethylene, perfluoroalkoxy alkane, perfluoroethylene propene copolymers, ethylene-tetrafluoroethylene copolymers, polyvinylidene fluoride, polychlorotrifluoroethylene, ethylene-chlorotrifluoroethylene copolymers, tetrafluoroethylene-perfluoroydioxole copolymers, and polyvinyl fluoride.

In the pigment dispersion contained in each ink of the first embodiment and the second embodiment of the invention, a pigment is dispersibly dispersed in water using a polymer in which 50% by weight or more of benzyl acrylate and 15% by weight or less of methacrylic acid and/or acrylic acid are polymerized as constituents. The benzyl acrylate can give a high color-developing property due to the Tg and the refractive index of the polymer, compared to the cases using other acrylic acid esters. The fixing property is increased when the amount of the benzyl acrylate is 50% by weight or more. The amount thereof is preferably 60% by weight or more and more preferably 70% by weight or more. Furthermore, the above-mentioned polymer is of the benzyl acrylate and 15% by weight or less of methacrylic acid and/or acrylic acid. When the blending amount of the methacrylic acid and/or acrylic acid is larger than 15% by weight (note that the term “blending amount” used herein means the total amount of the constituents selected from methacrylic acid and acrylic acid), the color-developing property of the inkjet ink tends to be decreased. The preferred range thereof is 10% by weight or less. Furthermore, the wet abrasion resistance can be also increased by controlling the blending amount of the methacrylic acid and/or acrylic acid to 15% by weight or less. The more preferred range is 10% by weight or less, also from the viewpoint of wet abrasion resistance. Furthermore, in the comparison of methacrylic acid and acrylic acid, the use of acrylic acid is more preferred from the viewpoint of fixing property.

In addition, the pigment dispersion contained in each ink of the first embodiment and the second embodiment of the invention preferably enables an organic pigment to be dispersed in water using the polymer and has an average particle size of 50 nm or more and 300 nm or less. In addition, the polymer preferably has a weight-average molecular weight, in terms of styrene, of 10000 or more and 200000 or less, measured by gel permeation chromatography (GPC). By controlling the weight-average molecular weight in terms of styrene to 10000 or more and 200000 or less, the fixing property of the pigment, in particular, as an ink for textile is increased, and the storage stability of the pigment ink is also increased. Furthermore, in addition to the above-mentioned polymer as a dispersant, a water-dispersible or water-soluble polymer or a surfactant may be added as a dispersion stabilizer for stabilizing the dispersion. The polymer used for dispersing the pigment is preferably a polymer by copolymerization of (meth)acrylate and (meth)acrylic acid in at least 80% by weight.

Furthermore, the ink of the second embodiment of the invention contains polymer microparticles as a fixing resin. The polymer microparticles have a glass transition temperature of 0° C. or less. By doing so, in particular, the fixing property of the pigment, in particular, as an ink for textile is increased. When the glass transition temperature is higher than 0° C., the fixing property of the pigment is gradually decreased. The glass transition temperature is preferably −5° C. or less and more preferably −10° C. or less. In addition, the polymer microparticles have an acid number of 100 mg KOH/g or less. When the acid number is larger than 100 mg KOH/g, the washing fastness in the case of printing on a fabric as that for textile is decreased. The acid number is preferably 50 mg KOH/g or less and more preferably 30 mg KOH/g or less. Furthermore, the molecular weight of the polymer microparticles is preferably 100000 or more and more preferably 200000 or more. When the molecular weight is smaller than 100000, the washing fastness is decreased in the case of printing on a fabric as that for textile. Furthermore, the addition amount of the polymer microparticles is preferably from 0.1 to 10% by weight. By controlling the addition amount to 10% by weight or less, solidification of the ink in a nozzle of an inkjet head is suppressed. The addition amount is more preferably 8% by weight or less.

In addition, the polymer microparticles contained in the ink of the second embodiment of the invention preferably have a weight-average molecular weight, in terms of styrene, of 100000 or more and 1000000 or less, measured by gel permeation chromatography (GPC). When the weight-average molecular weight in terms of styrene is 100000 or more and 1000000 or less, the fixing property of the pigment, in particular, as an ink for textile is increased. In addition, by controlling to 100000 or more as described above, the washing fastness in the case of printing on a fabric as that for textile becomes satisfactory.

Furthermore, the inks of the first embodiment and the second embodiment of the invention each preferably contain 1,2-alkylene glycol. By containing the 1,2-alkylene glycol, bleeding is reduced, and printing quality is increased. As examples of the 1,2-alkylene glycol used in the invention, 1,2-alkylene glycol having 5 or 6 carbon atoms, such as 1,2-hexanediol, 1,2-pentanediol, and 4-methyl-1,2-pentanediol, are preferred. Among them, 1,2-hexanediol and 4-methyl-1,2-pentanediol, which each have 6 carbon atoms, are preferred. The addition amount of such 1,2-alkylene glycol is from 0.3 to 30% by weight (hereinafter also simply referred to as “%”) and more preferably from 0.5 to 10%.

Furthermore, the inks of the first embodiment and the second embodiment of the invention each preferably contain glycol ether. As the glycol ether, diethylene glycol monobutyl ether, triethylene glycol monobutyl ether, propylene glycol monobutyl ether, and dipropylene glycol monobutyl ether are preferably used. The addition amount of such glycol ether is from 0.1 to 20% and more preferably from 0.5 to 10%.

Furthermore, the inks of the first embodiment and the second embodiment of the invention each preferably contain an acetylene glycol-based surfactant and/or an acetylene alcohol-based surfactant. By using the acetylene glycol-based surfactant and/or the acetylene alcohol-based surfactant, bleeding is further reduced, and printing quality is increased. The acetylene glycol-based surfactant and/or the acetylene alcohol-based surfactant used in the invention are preferably at least one selected from 2,4,7,9-tetramethyl-5-decine-4,7-diol, alkylene oxide adducts of 2,4,7,9-tetramethyl-5-decine-4,7-diol, 2,4-dimethyl-5-decin-4-01, and alkylene oxide adducts of 2,4-dimethyl-5-decin-4-ol. The acetylene glycol-based surfactant and/or the acetylene alcohol-based surfactant are available as Olfine 104 series of Air Products & Chemicals, Inc. (GB) and E series, such as Olfine E1010 series, and Surfynol 465 or Surfynol 61 of Nissin Chemical Industry Co. By adding such a surfactant, the drying property in printing is improved to enable high speed printing.

Furthermore, each ink of the first embodiment and the second embodiment of the invention can further decrease bleeding by containing at least two selected from the group consisting of the above-mentioned 1,2-alkylene glycol, acetylene glycol-based surfactant and/or acetylene alcohol-based surfactant, and glycol ether: for example, a combination of the 1,2-alkylene glycol and the acetylene glycol-based surfactant and/or the acetylene alcohol-based surfactant or a combination of the glycol ether and the acetylene glycol-based surfactant and/or the acetylene alcohol-based surfactant.

By thus producing an inkjet recording ink, the inkjet recording ink can be excellent in color-developing property, stability, and fixing property and be excellent, in particular, as an inkjet recording ink for textile.

As the pigment that can be used for a black ink in the invention, carbon blacks (C.I. pigment black 7), such as furnace black, lampblack, acetylene black, channel black, are particularly preferred, but metals such as copper oxide, iron oxide (C.I. pigment black 11), and titanium oxide and organic pigments such as aniline black (C.I. pigment black 1) can be also used.

Furthermore, as pigments for color inks, for example, C.I. pigment yellow 1 (fact yellow G), 3, 12 (disazo yellow AAA), 13, 14, 17, 24, 34, 35, 37, 42 (yellow iron oxide), 53, 55, 74, 81, 83 (disazo yellow HR), 93, 94, 95, 97, 98, 100, 101, 104, 108, 109, 110, 117, 120, 128, 138, 153, 155, 180, and 185; C.I. pigment red 1, 2, 3, 5, 17, 22 (brilliant fast scarlet), 23, 31, 38, 48:2 (permanent red 2B (Ba)), 48:2 (permanent red 2B (Ca)), 48:3 (permanent red 2B (Sr)), 48:4 (permanent red 2B (Mn)), 49:1, 52:2, 53:1, 57:1 (brilliant carmine 6B), 60:1, 63:1, 63:2, 64:1, 81 (rhodamine 6G lake), 83, 88, 101 (red oxide), 104, 105, 106, 108 (cadmium red), 112, 114, 122 (quinacridone magenda), 123, 146, 149, 166, 168, 170, 172, 177, 178, 179, 185, 190, 193, 202, 206, 209, and 219; C.I. pigment violet 19 and 23; C.I. pigment orange 36; C.I. pigment blue 1, 2, 15 (phthalocyanine blue R), 15:1, 15:2, 15:3 (phthalocyanine blue G), 15:4, 15:6 (phthalocyanine blue E), 16, 17:1, 56, 60, and 63; and C.I. pigment green 1, 4, 7, 8, 10, 17, 18, and 36 can be used.

Furthermore, the pigment used in the invention is dispersed using a disperser. In such a case, various commercially available dispersers can be used as the disperser, and non-media dispersion is preferred from the viewpoint of low contamination. Specific examples thereof include a wet jet mill (Genus Co., Ltd.), a nanomizer (Nanomizer Co., Ltd.), a homogenizer (Gaulin), an ultimizer (Sugino Machine Limited), and a microfluidizer (Microfluidics).

Furthermore, the amount of the pigment added to each ink of the first embodiment and the second embodiment of the invention is preferably from 0.5 to 30% and further preferably from 1.0 to 15%. In an addition amount not higher than the above, printing concentration cannot be secured, and an addition amount not lower than the above has a tendency of causing an increase in viscosity of the ink or a structural viscosity to the viscosity characteristic to worsen the discharge stability of the ink from an inkjet head.

Furthermore, the inks of the first embodiment and the second embodiment of the invention may each further contain various types of additives, such as a humectant, a dissolution aid, a penetration controlling agent, a viscosity modifier, a pH adjustor, a dissolution aid, an antioxidant, a preservative, an antifungal agent, a corrosion inhibitor, a chelate for capturing metal ions that influence the dispersion, for the purposes of securing of storage stability, stable discharge from an inkjet head, a reduction in clogging, prevention of ink degradation, and so on.

Furthermore, the inks of the first embodiment and the second embodiment of the invention are each preferably discharged by a method using an electrostriction element that does not generate heat, such as a piezo element. In the case of generating heat, such as a thermal head, the discharge tends to be unstable due to deterioration of the polymer microparticles contained in the ink or of the polymer used for dispersing the pigment. In particular, when a large volume of an ink is discharged for a long period of time, as an inkjet ink for textile, a head that generates heat is unpreferable.

### EXAMPLES

The invention will be more specifically described below. As Examples, cases in which pigments are dispersed with most preferable polymers will be shown, but the invention is not limited to these Examples only. In what follows, the term “part(s)” means “part(s) by weight”, and the term “%” means “% by weight”.

Examples of the ink of the first embodiment of the invention will be described below.

### Example A1

### (1) Production of Pigment Dispersion A1

In pigment dispersion A1, pigment blue 15:3 (copper phthalocyanine pigment: manufactured by Clariant) was used. A reaction vessel equipped with a stirrer, a thermometer, a reflux tube, and a dropping funnel was substituted by nitrogen, and then 75 parts of benzyl acrylate, 2 parts of acrylic acid, and 0.3 parts of t-dodecyl mercaptan were put in the vessel, followed by heating to 70° C. Separately prepared 150 parts of benzyl acrylate, 15 parts of acrylic acid, 5 parts of butyl acrylate, 1 part of t-dodecyl mercaptan, 20 parts of methyl ethyl ketone, and 1 part of sodium persulfate were dropwise added to the reaction vessel through the dropping funnel over 4 hours, thereby polymerizing a dispersion polymer. Then, methyl ethyl ketone was added to the reaction vessel to produce a solution of dispersion polymer having a concentration of 40%. The dispersion polymer had a molecular weight, in terms of styrene, of 100000, when measured by gel permeation chromatography (GPC) with an L7100 system manufactured by Hitachi Ltd. using THF as the solvent. The constitutional ratios of the benzyl acrylate and the acrylic acid blended in the dispersion polymer were 90% by weight and 6.9% by weight, respectively.

Furthermore, 40 parts of the dispersion polymer solution, 30 parts of pigment blue 15:3, 100 parts of a 0.1 mol/L aqueous solution of sodium hydroxide, and 30 parts of methyl ethyl ketone were mixed and were then subjected to dispersion by 15 passes at 200 MPa using an ultrahigh-pressure homogenizer (ultimizer HJP-25005 manufactured by Sugino Machine Co., Ltd.). Then, the resulting dispersion was transferred to another vessel, and 300 parts of ion-exchanged water were added thereto, followed by further stirring for 1 hour. Thereafter, the whole amount of the methyl ethyl ketone and a part of the water were distilled using a rotary evaporator, followed by neutralization with 0.1 mol/L sodium hydroxide to adjust the pH to 9. Then, filtering through a 0.3 μm membrane filter and adjustment with ion-exchanged water were performed to give pigment dispersion A1 having a pigment concentration of 15%. The particle size measured with a microtruck particle size distribution analyzer UPA 250 (manufactured by Nikkiso Co., Ltd.) was 80 nm.

### (2) Production of Fluorine Resin Particle Dispersion A1

As fluorine resin particles, polytetrafluoroethylene (hereinafter referred to as “PTFE”) powder (KTL-500F manufactured by Kitamura Ltd.: a primary particle size of 0.3 μm) was used. Thirty parts of KTL-500F, 100 parts of ion-exchanged water, and 10 parts of Olfine E1010 (Nissin Chemical Industry Co.) were mixed, followed by dispersion with an eiger mill using zirconia beads for 2 hours. Then, the resulting dispersion was transferred to another vessel, and 60 parts of ion-exchanged water were added thereto, followed by further stirring for 1 hour. Thereafter, the zirconia beads were removed, and filtering through a 10 μm membrane filter and adjustment with ion-exchanged water were performed to give fluorine resin particle dispersion A1 having a PTFE concentration of 15%.

### (3) Preparation of Inkjet Recording Ink

Table 2 shows examples of compositions suitable for the inkjet recording ink. The inkjet recording ink of the invention was prepared by using the pigment dispersion A1 and the fluorine resin particle dispersion A1 produced by the above-described processes and mixing them with the vehicle components shown in Table 2. In addition, the water used as balance in Examples of the invention and Comparative Examples was ion-exchanged water containing 0.05% Topside 240 (manufactured by Permachem Asia, Ltd.) for preventing corrosion of the ink, 0.02% benzotriazole for preventing corrosion of inkjet head members, and 0.04% ethylenediaminetetraacetic acid (EDTA) disodium salt for reducing the effect of metal ions in the ink system.

### (4) Abrasion Resistance Test and Dry-Cleaning Test

A solid pattern was printed on a cotton fabric using the ink of Example A1 and PX-V630 manufactured by Seiko Epson Corporation as the inkjet printer to form a sample. The sample was rubbed 100 times under a load of 200 g with a Gakushin-type rubbing fastness tester AB-301S manufactured by Tester Sangyo Co., Ltd. for rubbing fastness. The degree of detachment of the ink was evaluated according to Japanese Industrial Standard (JIS) JIS L0849 under two levels: dry and wet. Similarly, the dry-cleaning test was conducted according to Method B of JIS L0860 for evaluation. Table 1 shows the results of the abrasion resistance test and the dry-cleaning test.

### (5) Measurement of Discharge Stability

Evaluation was performed by printing 4000 letters/page of standard of character size of 11 and MSP Gothic of Microsoft Word on 100 pages of A4-size Xerox P paper manufactured by Fuji Xerox Co., Ltd. at 35° C. and 35% atmosphere by using the ink of Example A1 and the inkjet printer PX-V630 manufactured by Seiko Epson Corporation. The evaluation criteria were AA: no print defect was observed, A: one print defect was observed, B: two or three print defects were observed, C: four or five print defects were observed, and D: six or more print defects were observed. Table 1 shows the results.

### Example A2

### (1) Production of Pigment Dispersion A2

First, pigment dispersion A2 was produced as in the pigment dispersion A1 using pigment violet 19 (quinacridone pigment: manufactured by Clariant) to give the pigment dispersion A2. The particle size measured by the same method as in Example A1 was 90 nm.

### (2) Production of Fluorine Resin Particle Dispersion A1

The same fluorine resin particle dispersion A1 as in Example A1 was used.

### (3) Preparation of Inkjet Recording Ink

An ink was produced and evaluated as in Example A1 by mixing the pigment dispersion A2 produced by the above-described process with the vehicle components shown in Table 2.

### (4) Abrasion Resistance Test and Dry-Cleaning Test

The abrasion resistance test and the dry-cleaning test were carried out using the ink of Example A2 by the same method and the same evaluation method as in Example A1. Table 1 shows the results of the abrasion resistance test and the dry-cleaning test.

### (5) Measurement of Discharge Stability

The discharge stability was measured using the ink of Example A2 by the same method and the same evaluation method as in Example A1. Table 1 shows the measurement results of the discharge stability.

### Example A3

### (1) Production of Pigment Dispersion A3

First, pigment dispersion A3 was produced as in pigment dispersion A1 using pigment yellow 14 (azo-based pigment: manufactured by Clariant) to give the pigment dispersion A3. The particle size measured by the same method as in Example A1 was 115 nm.

### (2) Production of Fluorine Resin Particle Dispersion A1

The same fluorine resin particle dispersion A1 as in Example A1 was used.

### (3) Preparation of Inkjet Recording Ink

An ink was produced and evaluated as in Example A1 by mixing the pigment dispersion A3 produced by the above-described process with the vehicle components shown in Table 2.

### (4) Abrasion Resistance Test and Dry-Cleaning Test

The abrasion resistance test and the dry-cleaning test were carried out using the ink of Example A3 by the same method and the same evaluation method as in Example A1. Table 1 shows the results of the abrasion resistance test and the dry-cleaning test.

### (5) Measurement of Discharge Stability

The discharge stability was measured using the ink of Example A3 by the same method and the same evaluation method as in Example A1. Table 1 shows the measurement results of the discharge stability.

### Comparative Example A1

In Comparative Example A1, an ink was produced and evaluated as in Example A1 except that the fluorine resin particle dispersion in Example A1 was not added in the preparation of the inkjet recording ink. The ink composition is shown in Table 2. The abrasion resistance test, the dry-cleaning test, and the discharge stability test were carried out as in Example A1. Table 1 shows the results.

### Comparative Example A2

In Comparative Example A2, an ink was produced and evaluated as in Example A1 except that the fluorine resin particle dispersion A2 used in the preparation of inkjet recording ink in Example A1 had an average particle size of 600 nm. The ink composition is shown in Table 2. The abrasion resistance test, the dry-cleaning test, and the discharge stability test were carried out as in Example A1. Table 1 shows the results.

### Comparative Example A3

### (1) Production of Pigment Dispersion A4

In pigment dispersion A4, pigment violet 19 (quinacridone pigment: manufactured by Clariant) was used. A reaction vessel equipped with a stirrer, a thermometer, a reflux tube, and a dropping funnel was substituted by nitrogen, and then 45 parts of styrene, 30 parts of polyethylene glycol 400 acrylate, 10 parts of benzyl acrylate, 2 parts of acrylic acid, and 0.3 parts of t-dodecyl mercaptan were put in the vessel, followed by heating to 70° C. Separately prepared 150 parts of styrene, 100 parts of polyethylene glycol 400 acrylate, 15 parts of acrylic acid, 5 parts of butyl acrylate, 1 part of t-dodecyl mercaptan, 20 parts of methyl ethyl ketone, and 1 part of sodium persulfate were dropwise added to the reaction vessel through the dropping funnel over 4 hours, thereby polymerizing a dispersion polymer. Then, methyl ethyl ketone was added to the reaction vessel to produce a solution of dispersion polymer having a concentration of 40%. The constitutional ratio of the benzyl acrylate blended in the dispersion polymer was 2.8% by weight.

Furthermore, 40 parts of the dispersion polymer solution, 30 parts of pigment violet 19 (quinacridone pigment: manufactured by Clariant), 100 parts of a 0.1 mol/L aqueous solution of sodium hydroxide, and 30 parts of methyl ethyl ketone were mixed and were then subjected to dispersion by 15 passes at 200 MPa using an ultrahigh-pressure homogenizer (ultimizer HJP-25005 manufactured by Sugino Machine Co., Ltd.). Then, the resulting dispersion was transferred to another vessel, and 300 parts of ion-exchanged water were added thereto, followed by further stirring for 1 hour. Thereafter, the whole amount of the methyl ethyl ketone and a part of the water were distilled using a rotary evaporator, followed by neutralization with 0.1 mol/L sodium hydroxide to adjust the pH to 9. Then, filtering through a 0.3 μm membrane filter and adjustment with ion-exchanged water were performed to give pigment dispersion A4 having a pigment concentration of 15%. The particle size measured by the same method as in Example A1 was 105 nm.

### (2) Production of Fluorine Resin Particle Dispersion A1

The same fluorine resin particle dispersion A1 as in Example A1 was used.

### (3) Preparation of Inkjet Recording Ink

An ink was produced and evaluated as in Example A1 by mixing the pigment dispersion A4 produced by the above-described process with the vehicle components shown in Table 2.

### (4) Abrasion Resistance Test and Dry-Cleaning Test

The abrasion resistance test and the dry-cleaning test were carried out using the ink of Comparative Example A3 by the same method and the same evaluation method as in Example A1. Table 1 shows the results of the abrasion resistance test and the dry-cleaning test.

### (5) Measurement of Discharge Stability

The discharge stability was measured using the ink of Comparative Example A3 by the same method and the same evaluation method as in Example A1. Table 1 shows the measurement results of the discharge stability.

### Comparative Example A4

In Comparative Example A4, an ink was produced and evaluated as in Example A2 except that the pigment dispersion in Example A2 had a particle size of 350 nm. The particle size was measured by the same method as in Example A1. The dispersion having a particle size of 350 nm was used as pigment dispersion A2A. The ink composition is shown in Table 2. The abrasion resistance test, the dry-cleaning test, and the discharge stability test were carried out as in Example A1. Table 1 shows the results.

### Comparative Example A5

In Comparative Example A5, an ink was produced and evaluated as in Example A3 except that the fluorine resin particle dispersion in Example A3 was not added in the preparation of the inkjet recording ink. The ink composition is shown in Table 2. The abrasion resistance test, the dry-cleaning test, and the discharge stability test were carried out as in Example A1. Table 1 shows the results.

### Comparative Example A6

In Comparative Example A6, an ink was produced and evaluated as in Example A3 except that the pigment dispersion in Example A3 had a particle size of 360 nm. The particle size was measured by the same method as in Example A1. The dispersion having a particle size of 360 nm was used as pigment dispersion A3A. The ink composition is shown in Table 2. The abrasion resistance test, the dry-cleaning test, and the discharge stability test were carried out as in Example A1. Table 1 shows the results.

TABLE 1
Results of abrasion resistance, dry cleaning, and
discharge stability in Examples A1 to A3 and Comparative
Examples A1 to A6

| | Particle | Abrasion | | | Dis- |
|---|---|---|---|---|---|
| | size | resistance | | Dry | charge |
| | (nm) | Dry | Wet | Cleaning | stability |
| Example A1 | 80 | 4/5 | 4/5 | 4/5 | A |
| Example A2 | 90 | 5 | 4/5 | 4/5 | A |
| Example A3 | 115 | 5 | 4/5 | 4/5 | A |
| Comparative Example A1 | 80 | 2 | 2 | 4 | A |
| Comparative Example A2 | 80 | 4 | 2 | 3/4 | D |
| Comparative Example A3 | 105 | 2/3 | 2 | 2/3 | B |
| Comparative Example A4 | 350 | 3/4 | 3 | 3 | C |
| Comparative Example A5 | 115 | 3 | 2/3 | 4 | A |
| Comparative Example A6 | 360 | 3 | 3 | 3 | B |

Particle size: average particle size (nm) of pigment dispersion
Abrasion resistance and dry cleaning are based on evaluation standard of JIS.

TABLE 2
Ink compositions (% by weight) of Examples A1 to A3
and Comparative Examples A1 to A6

| | Example | | | Comparative Example | | | | | |
|---|---|---|---|---|---|---|---|---|---|
| | A1 | A2 | A3 | A1 | A2 | A3 | A4 | A5 | A6 |
| Pigment | 4.0 | — | — | 4.0 | 4.0 | — | — | — | — |
| dispersion A1 | | | | | | | | | |
| Pigment | — | 4.0 | — | — | — | — | — | — | — |
| dispersion A2 | | | | | | | | | |
| Pigment | — | — | — | — | — | — | 4.0 | — | — |
| dispersion | | | | | | | | | |
| A2A | | | | | | | | | |
| Pigment | — | — | 4.0 | — | — | — | — | 4.0 | — |
| dispersion A3 | | | | | | | | | |
| Pigment | — | — | — | — | — | — | — | — | 4.0 |
| dispersion | | | | | | | | | |
| A3A | | | | | | | | | |
| Pigment | — | — | — | — | — | 4.0 | — | — | — |
| dispersion A4 | | | | | | | | | |
| Fluorine resin | 5 | 5 | 4.5 | — | — | 5 | 5 | — | 4.5 |
| dispersion A1 | | | | | | | | | |
| Fluorine resin | — | — | — | — | 5 | — | — | — | — |
| dispersion A2 | | | | | | | | | |
| 1,2-HD | 3.0 | 3.0 | 2.0 | 3.0 | 3.0 | 3.0 | 3.0 | 2.0 | 2.0 |
| 1,2-PD | — | — | 1.0 | — | — | — | — | 1.0 | 1.0 |
| TEGmBE | 1.0 | 1.0 | 2.0 | 1.0 | 1.0 | 1.0 | 1.0 | 2.0 | 2.0 |
| S-104 | 0.3 | 0.3 | 0.3 | 0.3 | 0.3 | 0.3 | 0.3 | 0.3 | 0.3 |
| S-465 | 0.5 | 0.3 | 0.5 | 0.5 | 0.5 | 0.3 | 0.3 | 0.5 | 0.5 |
| S-61 | — | 0.2 | — | — | — | 0.2 | 0.2 | — | — |
| Glycerin | 12.0 | 10.0 | 10.0 | 14.0 | 12.0 | 10.0 | 10.0 | 12.0 | 10.0 |
| TMP | 3.0 | 3.0 | 3.0 | 3.0 | 3.0 | 3.0 | 3.0 | 3.0 | 3.0 |
| TEG | 5.0 | 4.0 | 4.0 | 5.0 | 5.0 | 4.0 | 4.0 | 4.0 | 4.0 |
| TEA | 1.0 | 1.0 | 1.0 | 1.0 | 1.0 | 1.0 | 1.0 | 1.0 | 1.0 |
| Ion- | balance | balance | balance | balance | balance | balance | balance | balance | balance |
| exchanged | | | | | | | | | |
| water | | | | | | | | | |

The ink composition (% by weight) of pigment dispersion shows solid content concentration of each pigment.
The ink composition (% by weight) of fluorine resin particle dispersion shows fluorine resin particle concentration.
1,2-HD: 1,2-hexanediol
1,2-PD: 1,2-heptanediol
TEGmBE: triethylene glycol monobutyl ether
S-104: Surfynol 104 (acetylene glycol-based surfactant manufactured by Nissin Chemical Industry Co.)
S-465: Surfynol 465 (acetylene glycol-based surfactant manufactured by Nissin Chemical Industry Co.)
S-61: Surfynol 61 (acetylene alcohol-based surfactant manufactured by Nissin Chemical Industry Co.)
TMP: trimethylolpropane
TEG: triethylene glycol
TEA: triethanolamine

### Example A4

### (1) Production of Pigment Dispersion A1

The same pigment dispersion A1 as in Example A1 was prepared and used as pigment dispersion.

### (2) Preliminary Arrangement of Fluorine Resin Particle Dispersion A3

Commercially available fluorine resin particles were used. Lubron PTFE aqueous dispersion LDW-410 (primary particle size: 0.2 μm, manufactured by Daikin Industries, Ltd.) was used as fluorine resin particle dispersion A3.

### (3) Preparation of Inkjet Recording Ink

An ink was produced as in Example A1 by mixing the above-mentioned pigment dispersion A1 and fluorine resin microparticle dispersion A3 with the vehicle components shown in Table 4.

### (4) Abrasion Resistance Test and Dry-Cleaning Test

A solid pattern was printed on a cotton fabric using the ink of Example A4 and PX-V630 manufactured by Seiko Epson Corporation as the inkjet printer to form a sample. The sample was rubbed 150 times under a load of 250 g with a Gakushin-type rubbing fastness tester AB-301S manufactured by Tester Sangyo Co., Ltd. for rubbing fastness (such a test in Example A4 was conducted under a higher load condition than that in Example A1 by increasing the load and the number of times of rubbing). The degree of detachment of the ink was evaluated according to Japanese Industrial Standard (JIS) JIS L0849 under two levels: dry and wet. Similarly, the dry-cleaning test was conducted according to Method B of JIS L0860 for evaluation. Table 3 shows the results of the abrasion resistance test and the dry-cleaning test.

### (5) Measurement of Discharge Stability

Evaluation was performed by printing 4000 letters/page of standard of character size of 11 and MSP Gothic of Microsoft Word on 100 pages of A4-size Xerox P paper manufactured by Fuji Xerox Co., Ltd. at 35° C. and 35% atmosphere by using the ink of Example A4 and the inkjet printer PX-V630 manufactured by Seiko Epson Corporation. The evaluation criteria were AA: no print defect was observed, A: one print defect was observed, B: two or three print defects were observed, C: four or five print defects were observed, and D: six or more print defects were observed. Table 3 shows the results.

### Example A5

In Example A5, an ink was produced and evaluated as in Example A4 except that the same pigment dispersion A2 as in Example A2 was prepared and used instead of the pigment dispersion A1 in Example A4.

The ink composition is shown in Table 4. The abrasion resistance test, the dry-cleaning test, and the discharge stability test were carried out as in Example A4. Table 3 shows the results.

### Comparative Example A7

### (1) Production of Pigment Dispersion A1

The same pigment dispersion A1 as in Example A1 was prepared and used as pigment dispersion.

### (2) Production of Polymer Microparticle

Polymer microparticles were used as a fixing resin instead of the fluorine resin particles. Commercially available polymer microparticles were used. In Comparative Example A7, acrylic resin emulsion was used as polymer microparticle EM-D. Table 3 shows the results. The polymer microparticle EM-D had a glass transition temperature of −12° C. when measured by a differential scanning calorimeter (EXSTAR6000DSC manufactured by Seiko Instruments, Inc.) and had a molecular weight, in terms of styrene, of 200000 when measured by gel permeation chromatography (GPC) with an L7100 system manufactured by Hitachi Ltd. using THF as the solvent. The polymer microparticle EM-D had an acid number of 30 mg KOH/g when measured according to the below-described method.

### (3) Preparation of Inkjet Recording Ink

An ink was produced as in Example A1 by mixing the above-described pigment dispersion A1 and polymer microparticle dispersion EM-D with the vehicle components shown in Table 4.

### (4) Abrasion resistance test and dry-cleaning test

Evaluation was performed as in Example A4 using the ink of Comparative Example A7. Table 3 shows the results of the abrasion resistance test and the dry-cleaning test.

### (5) Measurement of Discharge Stability

Evaluation was performed as in Example A4 using the ink of Comparative Example A7. Table 3 shows the results.

### Comparative Example A8

In Comparative Example A8, an ink having the composition shown in Table 4 was produced and evaluated as in Comparative Example A7 except that acrylic resin emulsion was used as polymer microparticle EM-E instead of the polymer microparticle EM-D in Comparative Example A7. Table 3 shows the results. The polymer microparticle EM-E had a glass transition temperature of −5° C. when measured by a differential scanning calorimeter (EXSTAR6000DSC manufactured by Seiko Instruments, Inc.) and had a molecular weight, in terms of styrene, of 200000 when measured by gel permeation chromatography (GPC) with an L7100 system manufactured by Hitachi Ltd. using THF as the solvent. The polymer microparticle EM-E had an acid number of 25 mg KOH/g when measured according to the below-described method.

### Comparative Example A9

In Comparative Example 9, an ink having the composition shown in Table 4 was produced and evaluated as in Comparative Example A7 except that the pigment dispersion A2 and an aqueous polyurethane resin as polymer microparticle PU-A were used instead of the pigment dispersion A1 and the polymer microparticle EM-D, respectively, in Comparative Example A7. Table 3 shows the results. The polymer microparticle PU-A had a glass transition temperature of −18° C. when measured by a differential scanning calorimeter (EXSTAR6000DSC manufactured by Seiko Instruments, Inc.) and had a molecular weight, in terms of styrene, of 200000 when measured by gel permeation chromatography (GPC) with an L7100 system manufactured by Hitachi Ltd. using THF as the solvent. The polymer microparticle PU-A had an acid number of 20 mg KOH/g when measured according to the below-described method.

### Comparative Example A10

In Comparative Example A10, an ink was produced and evaluated as in Comparative Example A9 except that an aqueous polyurethane resin was used as polymer microparticle PU-B instead of the polymer microparticle PU-A in Comparative Example A9. The ink composition is shown in Table 4. The abrasion resistance test, the dry-cleaning test, and the discharge stability test were carried out as in Example A4. Table 3 shows the results. The polymer microparticle PU-B had a glass transition temperature of −10° C. when measured by a differential scanning calorimeter (EXSTAR6000DSC manufactured by Seiko Instruments, Inc.) and had a molecular weight, in terms of styrene, of 200000 when measured by gel permeation chromatography (GPC) with an L7100 system manufactured by Hitachi Ltd. using THF as the solvent. The polymer microparticle PU-B had an acid number of 15 mg KOH/g when measured according to the below-described method.

### Comparative Example A11

### (1) Production of Pigment Dispersion A5

In pigment dispersion A5, pigment violet 19 (quinacridone pigment: manufactured by Clariant) was used. A reaction vessel equipped with a stirrer, a thermometer, a reflux tube, and a dropping funnel was substituted by nitrogen, and then 40 parts of benzyl acrylate, 10 parts of acrylic acid, 30 parts of butyl acrylate, and 0.3 parts of t-dodecyl mercaptan were put in the vessel, followed by heating to 70° C. Separately prepared 60 parts of benzyl acrylate, 37 parts of acrylic acid, 70 parts of butyl acrylate, 1 part of t-dodecyl mercaptan, 20 parts of methyl ethyl ketone, and 1 part of sodium persulfate were dropwise added to the reaction vessel through the dropping funnel over 4 hours, thereby polymerizing a dispersion polymer. Then, methyl ethyl ketone was added to the reaction vessel to produce a solution of dispersion polymer having a concentration of 40%. The dispersion polymer had a molecular weight, in terms of styrene, of 100000 when measured by gel permeation chromatography (GPC) with an L7100 system manufactured by Hitachi Ltd. using THF as the solvent. The constitutional ratios of the benzyl acrylate and the acrylic acid blended in the dispersion polymer were 40% by weight and 19% by weight, respectively.

Furthermore, 40 parts of the dispersion polymer solution, 30 parts of pigment violet 19 (quinacridone pigment: manufactured by Clariant), 100 parts of a 0.1 mol/L aqueous solution of sodium hydroxide, and 30 parts of methyl ethyl ketone were mixed and were then subjected to dispersion by 15 passes at 200 MPa using an ultrahigh-pressure homogenizer (ultimizer HJP-25005 manufactured by Sugino Machine Co., Ltd.). Then, the resulting dispersion was transferred to another vessel, and 300 parts of ion-exchanged water were added thereto, followed by further stirring for 1 hour. Thereafter, the whole amount of the methyl ethyl ketone and a part of the water were distilled using a rotary evaporator, followed by neutralization with 0.1 mol/L sodium hydroxide to adjust the pH to 9. Then, filtering through a 0.3 μm membrane filter and adjustment with ion-exchanged water were performed to give pigment dispersion A5 having a pigment concentration of 15%. The particle size measured by the same method as in Example A1 was 100 nm.

### (2) Preliminary Arrangement of Fluorine Resin Particle Dispersion A3

As the fluorine resin particles, the same fluorine resin particle dispersion A3 as in Example A4 was used.

### (3) Preparation of Inkjet Recording Ink

An ink was produced as in Example A1 by mixing the above-described pigment dispersion A5 and fluorine resin particle dispersion A3 with the vehicle components shown in Table 4.

### (4) Abrasion Resistance Test and Dry-Cleaning Test

Evaluation was performed as in Example A4 using the ink of Comparative Example A1. Table 3 shows the results of the abrasion resistance test and the dry-cleaning test.

### (5) Measurement of Discharge Stability

Evaluation was performed as in Example A4 using the ink of Comparative Example A1. Table 3 shows the results.

### Reference Example A1

In Reference Example A1, an ink was produced and evaluated as in Example A4 except that the addition amount of the fluorine resin particles in Example A4 was changed to less than 10% by weight of the pigment content.

The ink composition is shown in Table 4. The abrasion resistance test, the dry-cleaning test, and the discharge stability test were carried out as in Example A4. Table 3 shows the results.

### Reference Example A2

In Reference Example A2, an ink was produced and evaluated as in Example A4 except that the addition amount of the fluorine resin particles in Example A4 was changed to larger than 150% by weight of the pigment content.

The ink composition is shown in Table 4. The abrasion resistance test, the dry-cleaning test, and the discharge stability test were carried out as in Example A4. Table 3 shows the results.

TABLE 3
Results of abrasion resistance, dry cleaning, and
discharge stability in Examples A4 and A5, Comparative
Examples A7 to A11, and Reference Examples A1 and A2

| | | Abrasion | | | |
|---|---|---|---|---|---|
| | Particle | resistance | | | Dis- |
| | size | (reinforcement) | | Dry | charge |
| | (nm) | Dry | Wet | cleaning | stability |
| Example A4 | 80 | 5 | 4/5 | 4/5 | A |
| Example A5 | 90 | 5 | 4/5 | 4/5 | A |
| Comparative Example A7 | 80 | 3 | 3 | 4/5 | A |
| Comparative Example A8 | 80 | 3 | 3 | 4/5 | A |
| Comparative Example A9 | 90 | 3/4 | 3/4 | 4/5 | B |
| Comparative Example A10 | 90 | 3/4 | 3 | 4/5 | A |
| Comparative Example A11 | 100 | 3 | 2 | 3 | B |
| Reference Example A1 | 80 | 3/4 | 3/4 | 4/5 | A |
| Reference Example A2 | 80 | 5 | 4/5 | 4/5 | B |

Particle size: average particle size (nm) of pigment dispersion
Abrasion resistance and dry cleaning are based on evaluation standard of JIS.

TABLE 4
Ink compositions (% by weight) of Examples A4 and
A5, Comparative Examples A7 to A11, and Reference Examples
A1 and A2

| | | | | | | | | Reference | |
|---|---|---|---|---|---|---|---|---|---|
| | Example | | Comparative Example | | | | | Example | |
| | A4 | A5 | A7 | A8 | A9 | A10 | A11 | A1 | A2 |
| Pigment | 4.0 | — | 4.0 | 4.0 | — | — | — | 4.0 | 4.0 |
| dispersion A1 | | | | | | | | | |
| Pigment | — | 4.0 | — | — | 4.0 | 4.0 | — | — | — |
| dispersion A2 | | | | | | | | | |
| Pigment | — | — | — | — | — | — | 4.0 | — | — |
| dispersion A5 | | | | | | | | | |
| EM-D | — | — | 4.0 | — | — | — | — | — | — |
| EM-E | — | — | — | 4.0 | — | — | — | — | — |
| PU-A | — | — | — | — | 4.0 | — | — | — | — |
| PU-B | — | — | — | — | — | 4.0 | — | — | — |
| Fluorine resin | 4.0 | 3.5 | — | — | — | — | 3.5 | 0.3 | 6.5 |
| dispersion A3 | | | | | | | | | |
| 1,2-HD | 3.0 | 3.0 | 3.0 | 3.0 | 3.0 | 3.0 | 3.0 | 3.0 | 3.0 |
| TEGmBE | 1.0 | 1.0 | 1.0 | 1.0 | 1.0 | 1.0 | 1.0 | 1.0 | 1.0 |
| S-104 | 0.3 | 0.3 | 0.3 | 0.3 | 0.3 | 0.3 | 0.3 | 0.3 | 0.3 |
| S-465 | 0.5 | 0.3 | 0.5 | 0.5 | 0.3 | 0.3 | 0.3 | 0.5 | 0.5 |
| S-61 | — | 0.2 | — | — | 0.2 | 0.2 | 0.2 | — | — |
| Glycerin | 11.0 | 11.0 | 10.0 | 10.0 | 10.0 | 10.0 | 11.0 | 13.0 | 9.0 |
| TMP | 3.0 | 3.0 | 3.0 | 3.0 | 3.0 | 3.0 | 3.0 | 3.0 | 3.0 |
| TEG | 5.0 | 4.0 | 5.0 | 5.0 | 4.0 | 4.0 | 4.0 | 5.0 | 5.0 |
| TEA | 1.0 | 1.0 | 1.0 | 1.0 | 1.0 | 1.0 | 1.0 | 1.0 | 1.0 |
| Ion- | balance | balance | balance | balance | balance | balance | balance | balance | balance |
| exchanged | | | | | | | | | |
| water | | | | | | | | | |

The ink composition (% by weight) of pigment dispersion shows solid content concentration of each pigment.
The ink composition (% by weight) of polymer microparticle shows solid content concentration of each polymer microparticle.
The ink composition (% by weight) of fluorine resin particle dispersion shows fluorine resin particle concentration.
1,2-HD: 1,2-hexanediol
TEGmBE: triethylene glycol monobutyl ether
S-104: Surfynol 104 (acetylene glycol-based surfactant manufactured by Nissin Chemical Industry Co.)
S-465: Surfynol 465 (acetylene glycol-based surfactant manufactured by Nissin Chemical Industry Co.)
S-61: Surfynol 61 (acetylene alcohol-based surfactant manufactured by Nissin Chemical Industry Co.)
TMP: trimethylolpropane
TEG: triethylene glycol
TEA: triethanolamine

Examples of the ink of the second embodiment of the invention will be described below.

### Example B1

### (1) Production of Pigment Dispersion B1

In pigment dispersion B1, pigment blue 15:3 (copper phthalocyanine pigment: manufactured by Clariant) was used. A reaction vessel equipped with a stirrer, a thermometer, a reflux tube, and a dropping funnel was substituted by nitrogen, and then 75 parts of benzyl acrylate, 2 parts of acrylic acid, and 0.3 parts of t-dodecyl mercaptan were put in the vessel, followed by heating to 70° C. Separately prepared 150 parts of benzyl acrylate, 15 parts of acrylic acid, 5 parts of butyl acrylate, 1 part of t-dodecyl mercaptan, 20 parts of methyl ethyl ketone, and 1 part of sodium persulfate were dropwise added to the reaction vessel through the dropping funnel over 4 hours, thereby polymerizing a dispersion polymer. Then, methyl ethyl ketone was added to the reaction vessel to produce a solution of dispersion polymer having a concentration of 40%. The dispersion polymer had a molecular weight, in terms of styrene, of 100000 when measured by gel permeation chromatography (GPC) with an L7100 system manufactured by Hitachi Ltd. using THF as the solvent. The constitutional ratios of the benzyl acrylate and the acrylic acid blended in the dispersion polymer were 90% by weight and 6.9% by weight, respectively.

Furthermore, 40 parts of the dispersion polymer solution, 30 parts of pigment blue 15:3, 100 parts of a 0.1 mol/L aqueous solution of sodium hydroxide, and 30 parts of methyl ethyl ketone were mixed and were then subjected to dispersion by 15 passes at 200 MPa using an ultrahigh-pressure homogenizer (ultimizer HJP-25005 manufactured by Sugino Machine Co., Ltd.). Then, the resulting dispersion was transferred to another vessel, and 300 parts of ion-exchanged water were added thereto, followed by further stirring for 1 hour. Thereafter, the whole amount of the methyl ethyl ketone and a part of the water were distilled using a rotary evaporator, followed by neutralization with 0.1 mol/L sodium hydroxide to adjust the pH to 9. Then, filtering through a 0.3 μm membrane filter and adjustment with ion-exchanged water were performed to give pigment dispersion B1 having a pigment concentration of 15%. The particle size measured with a microtruck particle size distribution analyzer UPA 250 (manufactured by Nikkiso Co., Ltd.) was 80 nm.

### (2) Production of Polymer Microparticle

A reaction vessel was equipped with a dropping device, a thermometer, a water-cooled reflux condenser, and a stirrer, and 100 parts of ion-exchanged water were put in the vessel, and 0.2 parts of potassium persulfate serving as a polymerization initiator were added with stirring under a nitrogen atmosphere at 70° C. A monomer solution in which 40% of 100 parts of monomers consisting of 16 parts of styrene, 71 parts of ethyl acrylate, 11.5 parts of butyl acrylate, and 1.5 parts of methacrylic acid contains 7 parts of ion-exchanged water, 0.05 parts of sodium lauryl sulfate, and 0.02 parts of t-dodecyl mercaptan was dropwise added to the vessel at 70° C. for a reaction to produce a primary material. Two parts of a 10% solution of ammonium persulfate were added to the primary material, followed by stirring. Then, a reaction solution consisting of 30 parts of ion-exchanged water, 0.2 parts of potassium lauryl sulfate, the remains (60%) of the above-mentioned monomers, and 0.5 parts of t-dodecyl mercaptan was further added to the vessel with stirring at 70° C. for a polymerization reaction, followed by neutralization with sodium hydroxide to a pH of from 8 to 8.5 and filtering through a 0.3 μm filter to give a polymer microparticle aqueous dispersion as emulsion A (EM-A). An aliquot of this polymer microparticle aqueous dispersion was taken out and dried and then was measured for its glass transition temperature with a differential scanning calorimeter (EXSTAR6000DSC manufactured by Seiko Instruments, Inc.). The glass transition temperature was −15° C. The molecular weight in terms of styrene measured by gel permeation chromatography (GPC) with an L7100 system manufactured by Hitachi Ltd. using THF as the solvent was 200000.

Herein, the acid number was measured by the following method. The polymer microparticle aqueous dispersion before the neutralization with sodium hydroxide is sampled, and the solid content concentration thereof is precisely measured with a thermogravimetric analyzer (TG-2121 manufactured by Seiko Instruments Inc.). Then, about 10 g of the polymer microparticle aqueous dispersion is precisely weighed and is put in a stoppered conical flask. One hundred milliliters of 2-propanol-tetrahydrofuran (1:2) mixture solution is added to the flask for dissolution. This is titrated with a 0.1 mol/L 2-propanol solution of potassium hydroxide till a pink color persists for 30 seconds using a phenolphthalein as an indicator. The acid number is determined by the following expression (1):

Acid number (mg KOH/g)=(5.611×a×f)/S expression (1)

S: amount (g) of sample

a: consumption (mL) of 0.1 mol/L 2-propanol solution of potassium peroxide

f: factor of 0.1 mol/L 2-propanol solution of potassium peroxide

In addition, “a” means [titration value (mL)]−[blank value (mL)].

The acid number of the EM-A determined by the above-mentioned method was 10 mg KOH/g.

### (3) Production of Fluorine Resin Particle Dispersion B1

As fluorine resin particles, polytetrafluoroethylene (hereinafter referred to as “PTFE”) powder (KTL-500F manufactured by Kitamura Ltd.: a primary particle size of 0.3 μm) was used. Thirty parts of KTL-500F, 100 parts of ion-exchanged water, and 10 parts of Olfine E1010 (Nissin Chemical Industry Co.) were mixed, followed by dispersion with an eiger mill using zirconia beads for 2 hours. Then, the resulting dispersion was transferred to another vessel, and 60 parts of ion-exchanged water were added thereto, followed by further stirring for 1 hour. Thereafter, the zirconia beads were removed, and filtering through a 10 μl membrane filter and adjustment with ion-exchanged water were performed to give fluorine resin particle dispersion B1 having a PTFE concentration of 15%.

### (4) Preparation of Inkjet Recording Ink

Table 6 shows examples of compositions suitable for the inkjet recording ink. The inkjet recording ink of the invention was prepared by using the pigment dispersion B1, the polymer microparticle dispersion EM-A, and fluorine resin particle dispersion B1 produced by the above-described processes and mixing them with the vehicle components shown in Table 6. In addition, the water as balance in Examples of the invention and Comparative Examples was ion-exchanged water containing 0.05% Topside 240 (manufactured by Permachem Asia, Ltd.) for preventing corrosion of the ink, 0.02% benzotriazole for preventing corrosion of inkjet head members, and 0.04% ethylenediaminetetraacetic acid (EDTA) disodium salt for reducing the effect of metal ions in the ink system.

### (5) Abrasion Resistance Test and Dry-Cleaning Test

A solid pattern was printed on a cotton fabric using the ink in Example B1 and PX-V630 manufactured by Seiko Epson Corporation as the inkjet printer to form a sample. The sample was rubbed 100 times under a load of 200 g with a Gakushin-type rubbing fastness tester AB-301S manufactured by Tester Sangyo Co., Ltd. for rubbing fastness. The degree of detachment of the ink was evaluated according to Japanese Industrial Standard (JIS) JIS L0849 under two levels: dry and wet. Similarly, the dry-cleaning test was conducted according to Method B of JIS L0860 for evaluation. Table 5 shows the results of the abrasion resistance test and the dry-cleaning test.

### (6) Measurement of Discharge Stability

Evaluation was performed by printing 4000 letters/page of standard of character size of 11 and MSP Gothic of Microsoft Word on 100 pages of A4-size Xerox P paper manufactured by Fuji Xerox Co., Ltd. at 35° C. and 35% atmosphere by using the ink of Example B1 and the inkjet printer PX-V630 manufactured by Seiko Epson Corporation. The evaluation criteria were AA: no print defect was observed, A: one print defect was observed, B: two or three print defects were observed, C: four or five print defects were observed, and D: six or more print defects were observed. Table 5 shows the results.

### Example B2

### (1) Production of Pigment Dispersion B2

First, pigment dispersion B2 was produced as in pigment dispersion B1 using pigment violet 19 (quinacridone pigment: manufactured by Clariant) to give the pigment dispersion B2. The particle size measured by the same method as in Example B1 was 90 nm.

### (2) Production of Polymer Microparticle

The same polymer dispersion EM-A as in Example B1 was used.

### (3) Production of Fluorine Resin Particle Dispersion B1

The same fluorine resin particle dispersion B1 as in Example B1 was used.

### (4) Preparation of Inkjet Recording Ink

An ink was produced and evaluated as in Example B1 by mixing the pigment dispersion B2 produced by the above-described process with the vehicle components shown in Table 6.

### (5) Abrasion Resistance Test and Dry-Cleaning Test

The abrasion resistance test and the dry-cleaning test were conducted using the ink of Example B2 by the same method and the same evaluation method as in Example B1. Table 5 shows the results of the abrasion resistance test and the dry-cleaning test.

### (6) Measurement of Discharge Stability

The discharge stability was measured using the ink of Example B2 by the same method and the same evaluation method as in Example B1. Table 5 shows the measurement results of the discharge stability.

### Example B3

### (1) Production of Pigment Dispersion B3

First, pigment dispersion 83 was produced as in the pigment dispersion B1 using pigment yellow 14 (azo-based pigment: manufactured by Clariant) to give the pigment dispersion B3. The particle size measured by the same method as in Example B1 was 115 nm.

### (2) Production of Polymer Microparticle

The same polymer dispersion EM-A as in Example B1 was used.

### (3) Production of Fluorine Resin Particle Dispersion B1

The same fluorine resin particle dispersion B1 as in Example B1 was used.

### (4) Preparation of Inkjet Recording Ink

An ink was produced and evaluated as in Example B1 by mixing the pigment dispersion B3 produced by the above-described process with the vehicle components shown in Table 6.

### (5) Abrasion Resistance Test and Dry-Cleaning Test

The abrasion resistance test and the dry-cleaning test were conducted using the ink of Example B3 by the same method and the same evaluation method as in Example B1. Table 5 shows the results of the abrasion resistance test and the dry-cleaning test.

### (6) Measurement of Discharge Stability

The discharge stability was measured using the ink of Example B3 by the same method and the same evaluation method as in Example B1. Table 5 shows the measurement results of the discharge stability.

### Comparative Example B1

In Comparative Example B1, an ink was produced and evaluated as in Example B1 except that the polymer microparticle dispersion and the fluorine resin particle dispersion in Example B1 were not added in the preparation of the inkjet recording ink. The ink composition is shown in Table 6. The abrasion resistance test, the dry-cleaning test, and the discharge stability test were carried out as in Example B1. Table 5 shows the results.

### Comparative Example B2

In Comparative Example B2, an ink was produced and evaluated as in Example B1 except that the fluorine resin particle dispersion B2 used in the preparation of the inkjet recording ink in Example B1 had an average particle size of 600 nm. The ink composition is shown in Table 6. The abrasion resistance test, the dry-cleaning test, and the discharge stability test were carried out as in Example B1. Table 5 shows the results.

### Comparative Example B3

### (1) Production of Pigment Dispersion B4

In pigment dispersion B4, pigment violet 19 (quinacridone pigment: manufactured by Clariant) was used. A reaction vessel equipped with a stirrer, a thermometer, a reflux tube, and a dropping funnel was substituted by nitrogen, and then 45 parts of styrene, 30 parts of polyethylene glycol 400 acrylate, 10 parts of benzyl acrylate, 2 parts of acrylic acid, and 0.3 parts of t-dodecyl mercaptan were put in the vessel, followed by heating to 70° C. Separately prepared 150 parts of styrene, 100 parts of polyethylene glycol 400 acrylate, 15 parts of acrylic acid, 5 parts of butyl acrylate, 1 part of t-dodecyl mercaptan, 20 parts of methyl ethyl ketone, and 1 part of sodium persulfate were dropwise added to the reaction vessel through the dropping funnel over 4 hours, thereby polymerizing a dispersion polymer. Then, methyl ethyl ketone was added to the reaction vessel to produce a solution of dispersion polymer having a concentration of 40%. The constitutional ratio of the benzyl acrylate blended in the dispersion polymer was 2.8% by weight.

Furthermore, 40 parts of the dispersion polymer solution, 30 parts of pigment violet 19 (quinacridone pigment: manufactured by Clariant), 100 parts of a 0.1 mol/L aqueous solution of sodium hydroxide, and 30 parts of methyl ethyl ketone were mixed and were then subjected to dispersion by 15 passes at 200 MPa using an ultrahigh-pressure homogenizer (ultimizer HJP-25005 manufactured by Sugino Machine Co., Ltd.). Then, the resulting dispersion was transferred to another vessel, and 300 parts of ion-exchanged water were added thereto, followed by further stirring for 1 hour. Thereafter, the whole amount of the methyl ethyl ketone and a part of the water were distilled using a rotary evaporator, followed by neutralization with 0.1 mol/L sodium hydroxide to adjust the pH to 9. Then, filtering through a 0.3 μm membrane filter and adjustment with ion-exchanged water were performed to give pigment dispersion B4 having a pigment concentration of 15%. The particle size measured by the same method as in Example B1 was 105 nm.

### (2) Production of Polymer Microparticle

The same polymer dispersion EM-A as in Example B1 was used.

### (3) Production of Fluorine Resin Particle Dispersion B1

The same fluorine resin particle dispersion B1 as in Example B1 was used.

### (4) Preparation of Inkjet Recording Ink

An ink was produced and evaluated as in Example B1 by mixing the pigment dispersion B4 produced by the above-described process with the vehicle components shown in Table 6.

### (5) Abrasion Resistance Test and Dry-Cleaning Test

The abrasion resistance test and the dry-cleaning test were conducted using the ink of Comparative Example B3 by the same method and the same evaluation method as in Example B1. Table 5 shows the results of the abrasion resistance test and the dry-cleaning test.

### (6) Measurement of Discharge Stability

The discharge stability was measured using the ink of Comparative Example B3 by the same method and the same evaluation method as in Example B1. Table 5 shows the measurement results of the discharge stability.

### Comparative Example B4

In Comparative Example B4, an ink was produced and evaluated as in Example B2 except that the pigment dispersion in Example B2 had a particle size of 350 nm. The particle size was measured by the same method as in Example B1. The dispersion having a particle size of 350 nm was used as pigment dispersion B2A. The ink composition is shown in Table 6. The abrasion resistance test, the dry-cleaning test, and the discharge stability test were carried out as in Example B1. Table 5 shows the results.

### Comparative Example B5

In Comparative Example B5, an ink was produced and evaluated as in Example B3 except that the polymer microparticle dispersion and the fluorine resin particle dispersion in Example B3 were not added in the preparation of the inkjet recording ink. The ink composition is shown in Table 6. The abrasion resistance test, the dry-cleaning test, and the discharge stability test were carried out as in Example B1. Table 5 shows the results.

### Comparative Example B6

In Comparative Example B6, an ink was produced and evaluated as in Example B3 except that the pigment dispersion in Example B3 had a particle size of 360 nm. The particle size was measured by the same method as in Example B1. The dispersion having a particle size of 360 nm was used as pigment dispersion 83A. The ink composition is shown in Table 6. The abrasion resistance test, the dry-cleaning test, and the discharge stability test were carried out as in Example B1. Table 5 shows the results.

TABLE 5
Results of abrasion resistance, dry cleaning, and
discharge stability in Examples B1 to B3 and Comparative
Examples B1 to B6

| | Particle | Abrasion | | | |
|---|---|---|---|---|---|
| | size | resistance | | Dry | Discharge |
| | (nm) | Dry | Wet | cleaning | stability |
| Example B1 | 80 | 5 | 4/5 | 4/5 | A |
| Example B2 | 90 | 5 | 4/5 | 4/5 | A |
| Example B3 | 115 | 5 | 4/5 | 4/5 | A |
| Comparative Example B1 | 80 | 2 | 2 | 4 | A |
| Comparative Example B2 | 80 | 2/3 | 2/3 | 3/4 | D |
| Comparative Example B3 | 105 | 2 | 3 | 3 | B |
| Comparative Example B4 | 350 | 3 | 3/4 | 3 | C |
| Comparative Example B5 | 115 | 3 | 4 | 2/3 | A |
| Comparative Example B6 | 360 | 2 | 4 | 3/4 | C |

Particle size: average particle size (nm) of pigment dispersion
Abrasion resistance and dry cleaning are based on evaluation standard of JIS.

TABLE 6
Ink compositions (% by weight) of Examples B1 to B3
and Comparative Examples B1 to B6

| | Example | | | Comparative Example | | | | | |
|---|---|---|---|---|---|---|---|---|---|
| | B1 | B2 | B3 | B1 | B2 | B3 | B4 | B5 | B6 |
| Pigment | 3.5 | — | — | 3.5 | 3.5 | — | — | — | — |
| dispersion B1 | | | | | | | | | |
| Pigment | — | 4.0 | — | — | — | — | — | — | — |
| dispersion B2 | | | | | | | | | |
| Pigment | — | — | — | — | — | — | 4.0 | — | — |
| dispersion | | | | | | | | | |
| B2A | | | | | | | | | |
| Pigment | — | — | 4.0 | — | — | — | — | 4.0 | — |
| dispersion B3 | | | | | | | | | |
| Pigment | — | — | — | — | — | — | — | — | 4.0 |
| dispersion | | | | | | | | | |
| B3A | | | | | | | | | |
| Pigment | — | — | — | — | — | 4.0 | — | — | — |
| dispersion B4 | | | | | | | | | |
| EM-A | 3.5 | 3.5 | 3.5 | — | 3.5 | 3.5 | 3.5 | — | 3.5 |
| Fluorine resin | 1.5 | 1.5 | 1.0 | — | — | 1.5 | 1.5 | — | 1.0 |
| dispersion B1 | | | | | | | | | |
| Fluorine resin | — | — | — | — | 1.5 | — | — | — | — |
| dispersion B2 | | | | | | | | | |
| 1,2-HD | 3.0 | 3.0 | 2.0 | 3.0 | 3.0 | 3.0 | 3.0 | 2.0 | 2.0 |
| 1,2-PD | — | — | 1.0 | — | — | — | — | 1.0 | 1.0 |
| TEGmBE | 1.0 | 1.0 | 2.0 | 1.0 | 1.0 | 1.0 | 1.0 | 2.0 | 2.0 |
| S-104 | 0.3 | 0.3 | 0.3 | 0.3 | 0.3 | 0.3 | 0.3 | 0.3 | 0.3 |
| S-465 | 0.5 | 0.3 | 0.5 | 0.5 | 0.5 | 0.3 | 0.3 | 0.5 | 0.5 |
| S-61 | — | 0.2 | — | — | — | 0.2 | 0.2 | — | — |
| Glycerin | 12.0 | 10.0 | 10.0 | 16.0 | 12.0 | 10.0 | 10.0 | 14.0 | 10.0 |
| TMP | 3.0 | 3.0 | 3.0 | 3.0 | 3.0 | 3.0 | 3.0 | 3.0 | 3.0 |
| TEG | 5.0 | 4.0 | 4.0 | 5.0 | 5.0 | 4.0 | 4.0 | 4.0 | 4.0 |
| TEA | 1.0 | 1.0 | 1.0 | 1.0 | 1.0 | 1.0 | 1.0 | 1.0 | 1.0 |
| Ion- | balance | balance | balance | balance | balance | balance | balance | balance | balance |
| exchanged | | | | | | | | | |
| water | | | | | | | | | |

The ink composition (% by weight) of pigment dispersion shows solid content concentration of each pigment.
The ink composition (% by weight) of fluorine resin particle dispersion shows fluorine resin particle concentration.
1,2-HD: 1,2-hexanediol
1,2-PD: 1,2-heptanediol
TEGmBE: triethylene glycol monobutyl ether
S-104: Surfynol 104 (acetylene glycol-based surfactant manufactured by Nissin Chemical Industry Co.)
S-465: Surfynol 465 (acetylene glycol-based surfactant manufactured by Nissin Chemical Industry Co.)
S-61: Surfynol 61 (acetylene alcohol-based surfactant manufactured by Nissin Chemical Industry Co.)
TMP: trimethylolpropane
TEG: triethylene glycol
TEA: triethanolamine

### Example B4

### (1) Production of Pigment Dispersion B5

First, in pigment dispersion B5, pigment blue 15:3 (copper phthalocyanine pigment: manufactured by Clariant) was used. A reaction vessel equipped with a stirrer, a thermometer, a reflux tube, and a dropping funnel was substituted by nitrogen, and then 75 parts of benzyl acrylate, 2 parts of acrylic acid, and 0.3 parts of t-dodecyl mercaptan were put in the vessel, followed by heating to 70° C. Separately prepared 150 parts of benzyl acrylate, 15 parts of acrylic acid, 5 parts of butyl acrylate, 1 part of t-dodecyl mercaptan, 20 parts of methyl ethyl ketone, and 1 part of sodium persulfate were dropwise added to the reaction vessel through the dropping funnel over 4 hours, thereby polymerizing a dispersion polymer. Then, methyl ethyl ketone was added to the reaction vessel to produce a solution of dispersion polymer having a concentration of 40%. The dispersion polymer had a molecular weight, in terms of styrene, of 100000 when measured by gel permeation chromatography (GPC) with an L7100 system manufactured by Hitachi Ltd. using THF as the solvent. The constitutional ratios of the benzyl acrylate and the acrylic acid blended in the dispersion polymer were 90% by weight and 6.9% by weight, respectively.

Furthermore, 40 parts of the dispersion polymer solution, 30 parts of pigment blue 15:3, 100 parts of a 0.1 mol/L aqueous solution of sodium hydroxide, and 30 parts of methyl ethyl ketone were mixed and were then subjected to dispersion with an eiger mill using zirconia beads for 2 hours. Then, the resulting dispersion was transferred to another vessel, and 300 parts of ion-exchanged water were added thereto, followed by further stirring for 1 hour. Thereafter, the whole amount of the methyl ethyl ketone and a part of the water were distilled using a rotary evaporator, followed by neutralization with 0.1 mol/L sodium hydroxide to adjust the pH to 9. Then, filtering through a 0.3 μm membrane filter and adjustment with ion-exchanged water were performed to give pigment dispersion B5 having a pigment concentration of 15%. The particle size measured by the same method as in Example B1 was 80 nm.

### (2) Preparation of Polymer Microparticle

The same polymer dispersion EM-A as in Example B1 was used.

### (3) Production of Fluorine Resin Particle Dispersion B1

The same fluorine resin particle dispersion B1 as in Example B1 was used.

### (4) Preparation of Inkjet Recording Ink

An ink was produced and evaluated as in Example B1 by mixing the pigment dispersion B5 produced by the above-described process with the vehicle components shown in Table 8.

### (5) Abrasion Resistance Test and Dry-Cleaning Test

The abrasion resistance test and the dry-cleaning test were conducted using the ink of Example B4 by the same method and the same evaluation method as in Example B1. Table 7 shows the results of the abrasion resistance test and the dry-cleaning test.

### (6) Measurement of Discharge Stability

The discharge stability was measured using the ink of Example B4 by the same method and the same evaluation method as in Example B1. Table 7 shows the measurement results of the discharge stability.

### Example B5

In Example B5, an ink was produced and evaluated as in Example B4 except that the pigment dispersion B6 produced using pigment violet 19 (quinacridone pigment: manufactured by Clariant) instead of the pigment blue 15:3 in Example B4 was used. The particle size measured by the same method as in Example B1 was 90 nm. The ink composition is shown in Table 8. The abrasion resistance test, the dry-cleaning test, and the discharge stability test were carried out as in Example B1. Table 7 shows the results.

### Example B6

In Example B6, an ink was produced and evaluated as in Example B4 except that the pigment dispersion B7 produced using pigment yellow 14 (azo-based pigment: manufactured by Clariant) instead of the pigment blue 15:3 in Example B4 was used. The particle size measured by the same method as in Example B1 was 115 nm. The ink composition is shown in Table 8. The abrasion resistance test, the dry-cleaning test, and the discharge stability test were carried out as in Example B1. Table 7 shows the results.

### Comparative Example B7

### (1) Production of Pigment Dispersion B5

The same pigment dispersion B5 as in Example B4 was used.

### (2) Production of Polymer Microparticle

A reaction vessel was equipped with a dropping device, a thermometer, a water-cooled reflux condenser, and a stirrer, and 100 parts of ion-exchanged water were put in the vessel, and 0.2 parts of potassium persulfate serving as a polymerization initiator were added with stirring under a nitrogen atmosphere at 70° C. A monomer solution in which 40% of 100 parts of monomers consisting of 15 parts of styrene, 22 parts of benzyl acrylate, 50 parts of ethyl acrylate, 11.5 parts of butyl acrylate, and 1.5 parts of methacrylic acid contains 7 parts of ion-exchanged water, 0.05 parts of sodium lauryl sulfate, and 0.02 parts of t-dodecyl mercaptan was dropwise added to the vessel at 70° C. for a reaction to produce a primary material. Two parts of a 10% solution of ammonium persulfate were added to the primary material, followed by stirring. Then, a reaction solution consisting of 30 parts of ion-exchanged water, 0.2 parts of potassium lauryl sulfate, the remains (60%) of the above-mentioned monomers, and 0.5 parts of t-dodecyl mercaptan was further added to the vessel with stirring at 70° C. for a polymerization reaction, followed by neutralization with sodium hydroxide to a pH of from 8 to 8.5 and filtering through a 0.3 μm filter to give a polymer microparticle aqueous dispersion as emulsion B (EM-B). The glass transition temperature measured as in Example B1 was 15° C., the molecular weight in terms of styrene measured using THF as the solvent was 200000, and the acid number was 10 mg KOH/g.

### (3) Production of Fluorine Resin Particle Dispersion B1

The same fluorine resin particle dispersion B1 as in Example B1 was used.

### (4) Preparation of Inkjet Recording Ink

An ink was produced and evaluated as in Example B1 by mixing the pigment dispersion B5 produced by the above-described process with the vehicle components shown in Table 8.

### (5) Abrasion Resistance Test and Dry-Cleaning Test

The abrasion resistance test and the dry-cleaning test were conducted using the ink of Comparative Example B7 by the same method and the same evaluation method as in Example B1. Table 7 shows the results of the abrasion resistance test and the dry-cleaning test.

### (6) Measurement of Discharge Stability

The discharge stability was measured using the ink of Comparative Example B7 by the same method and the same evaluation method as in Example B1. Table 7 shows the measurement results of the discharge stability.

### Comparative Example B8

In Comparative Example B8, an ink was produced and evaluated as in Example B5 except that the polymer microparticles use in Example B5 had an acid number of 140 mg KOH/g. The emulsion having an acid number of 140 mg KOH/g was used as emulsion C (EM-C). The glass transition temperature and the molecular weight of the EM-C measured as in Example B1 were −17° C. and 200000, respectively. The ink composition is shown in Table 8. The abrasion resistance test, the dry-cleaning test, and the discharge stability test were carried out as in Example B1. Table 7 shows the results.

### Comparative Example B9

In Comparative Example B9, an ink was produced and evaluated as in Example B6 except that the EM-B was used as the polymer microparticles used in Example B6. The ink composition is shown in Table 8. The abrasion resistance test, the dry-cleaning test, and the discharge stability test were carried out as in Example B1. Table 7 shows the results.

TABLE 7
Results of abrasion resistance, dry cleaning, and
discharge stability in Examples B4 to B6 and Comparative
Examples B7 to B9

| | Polymer | | | Abrasion | | | |
|---|---|---|---|---|---|---|---|
| | microparticle | | | resistance | | Dry | Discharge |
| | Tg | Tg | Acid number | Dry | Wet | cleaning | stability |
| Example B4 | −15 | 2 | 10 | 4/5 | 5 | 4/5 | A |
| Example B5 | −15 | 2 | 10 | 4/5 | 5 | 4/5 | A |
| Example B6 | −15 | 2 | 10 | 4/5 | 5 | 4/5 | A |
| Comparative Example B7 | 15 | 2 | 10 | 2/3 | 3 | 3 | A |
| Comparative Example B8 | −17 | 2 | 140 | 4 | 4 | 2 | B |
| Comparative Example B9 | 15 | 2 | 10 | 3 | 3 | 3 | A |

Molecular weight: ×10⁵
Abrasion resistance and dry cleaning are based on evaluation standard of JIS.

TABLE 8
Ink compositions (% by weight) of Examples B4 to B6
and Comparative Examples B7 to B9

| | Example | | | Comparative Example | | |
|---|---|---|---|---|---|---|
| | B4 | B5 | B6 | B7 | B8 | B9 |
| Pigment dispersion B5 | 3.5 | — | — | 3.5 | — | — |
| Pigment dispersion B6 | — | 4.0 | — | — | 4.0 | — |
| Pigment dispersion B7 | — | — | 4.0 | — | — | 4.0 |
| EM-A | 4.0 | 4.0 | 4.0 | — | — | — |
| EM-B | — | — | — | 4.0 | — | 4.0 |
| EM-C | — | — | — | — | 4.0 | — |
| Fluorine resin dispersion B1 | 1.0 | 1.0 | 1.0 | 1.0 | 1.0 | 1.0 |
| 1,2-HD | 3.0 | 3.0 | 2.0 | 3.0 | 3.0 | 2.0 |
| 1,2-PD | — | — | 1.0 | — | — | 1.0 |
| TEGmBE | 1.0 | 1.0 | 2.0 | 1.0 | 1.0 | 2.0 |
| S-104 | 0.3 | 0.3 | 0.3 | 0.3 | 0.3 | 0.3 |
| S-465 | 0.5 | 0.3 | 0.5 | 0.5 | 0.3 | 0.5 |
| S-61 | — | 0.2 | — | — | 0.2 | — |
| Glycerin | 12.0 | 10.0 | 10.0 | 12.0 | 10.0 | 10.0 |
| TMP | 3.0 | 3.0 | 3.0 | 3.0 | 3.0 | 3.0 |
| TEG | 5.0 | 4.0 | 4.0 | 5.0 | 4.0 | 4.0 |
| TEA | 1.0 | 1.0 | 1.0 | 1.0 | 1.0 | 1.0 |
| Ion-exchanged water | balance | balance | balance | balance | balance | balance |

The ink composition (% by weight) of pigment dispersion shows solid content concentration of each pigment.
The ink composition (% by weight) of fluorine resin particle dispersion shows fluorine resin particle concentration.
The ink composition (% by weight) of polymer microparticle shows solid content concentration of each polymer microparticle.
1,2-HD: 1,2-hexanediol
1,2-PD: 1,2-heptanediol
TEGmBE: triethylene glycol monobutyl ether
S-104: Surfynol 104 (acetylene glycol-based surfactant manufactured by Nissin Chemical Industry Co.)
S-465: Surfynol 465 (acetylene glycol-based surfactant manufactured by Nissin Chemical Industry Co.)
S-61: Surfynol 61 (acetylene alcohol-based surfactant manufactured by Nissin Chemical Industry Co.)
TMP: trimethylolpropane
TEG: triethylene glycol
TEA: triethanolamine

### Example B7

### (1) Production of Pigment Dispersion B1

The same pigment dispersion as in Example B1 was prepared and used as pigment dispersion B1.

### (2) Production of Polymer Microparticle

Commercially available polymer microparticles were used. In Example B7, acrylic resin emulsion was used as polymer microparticle EM-D. The polymer microparticle had a glass transition temperature of −12° C. when measured as in Example B1, a molecular weight, in terms of styrene, of 200000 when measured as in Example B1 using THF as the solvent, and an acid number of 30 mg KOH/g.

### (3) Preliminary Arrangement of Fluorine Resin Particle Dispersion B3

Commercially available fluorine resin particles were used. Lubron PTFE aqueous dispersion LDW-410 (primary particle size: 0.2 μm, manufactured by Daikin Industries, Ltd.) was used as fluorine resin particle dispersion B3.

### (4) Preparation of Inkjet Recording Ink

An ink was produced as in Example B1 by mixing the above-mentioned pigment dispersion B1, the polymer microparticle dispersion EM-D, and the fluorine resin microparticle dispersion B3 with the vehicle components shown in Table 10.

### (5) Abrasion Resistance Test and Dry-Cleaning Test

A solid pattern was printed on a cotton fabric using the ink of Example B7 and PX-V630 manufactured by Seiko Epson Corporation as the inkjet printer to form a sample. The sample was rubbed 150 times under a load of 250 g with a Gakushin-type rubbing fastness tester AB-301S manufactured by Tester Sangyo Co., Ltd. for rubbing fastness (such a test in Example B7 was conducted under a higher load condition than that in Example B1 by increasing the load and the number of times of rubbing). The degree of detachment of the ink was evaluated according to Japanese Industrial Standard (JIS) JIS L0849 under two levels: dry and wet. Similarly, the dry-cleaning test was conducted according to Method B of JIS L0860 for evaluation. Table 9 shows the results of the abrasion resistance test and the dry-cleaning test.

### (6) Measurement of Discharge Stability

Evaluation was performed by printing 4000 letters/page of standard of character size of 11 and MSP Gothic of Microsoft Word on 100 pages of A4-size Xerox P paper manufactured by Fuji Xerox Co., Ltd. at 35° C. and 35% atmosphere by using the ink of Example B7 and the inkjet printer PX-V630 manufactured by Seiko Epson Corporation. The evaluation criteria were AA: no print defect was observed, A: one print defect was observed, B: two or three print defects were observed, C: four or five print defects were observed, and D: six or more print defects were observed. Table 9 shows the results.

### Example B8

In Example B8, an ink was produced and evaluated as in Example B7 except that acrylic resin emulsion was used as the polymer microparticle EM-E in Example B7. The polymer microparticle EM-E had a glass transition temperature of −5° C., a molecular weight, in terms of styrene, of 200000 when measured as in Example B1 using THF as the solvent, and an acid number of 25 mg KOH/g.

The ink composition is shown in Table 10. The abrasion resistance test, the dry-cleaning test, and the discharge stability test were carried out as in Example B7. Table 9 shows the results.

### Example B9

### (1) Production of Pigment Dispersion B2

The same pigment dispersion as in Example B2 was prepared and used as pigment dispersion B2.

### (2) Preliminary Arrangement of Polymer Microparticle

Commercially available polymer microparticles were used. In Example B9, an aqueous polyurethane resin was used as polymer microparticle PU-A. The polymer microparticle PU-A had a glass transition temperature of −18° C. when measured as in Example B1, a molecular weight, in terms of styrene, of 200000 when measured as in Example B1 using THF as the solvent, and an acid number of 20 mg KOH/g.

### (3) Preliminary Arrangement of Fluorine Resin Particle Dispersion B3

The fluorine resin particle dispersion B3 was used as the fluorine resin particles as in Example B7.

### (4) Preparation of Inkjet Recording Ink

An ink was produced as in Example B1 by mixing the above-mentioned pigment dispersion B2, the polymer microparticle dispersion PU-A, and the fluorine resin particle dispersion B3 with the vehicle components shown in Table 10.

### (5) Abrasion Resistance Test and Dry-Cleaning Test

Evaluation was conducted using the ink of Example B9 as in Example B7. Table 9 shows the results of the abrasion resistance test and the dry-cleaning test.

### (6) Measurement of Discharge Stability

Evaluation was conducted using the ink of Example B9 as in Example B7. Table 9 shows the results.

### Example B10

In Example B10, an ink was produced and evaluated as in Example B9 except that an aqueous polyurethane resin was used as the polymer microparticle PU-B in Example B9. The ink composition is shown in Table 10. The abrasion resistance test, the dry-cleaning test, and the discharge stability test were carried out as in Example B7. Table 9 shows the results. The glass transmition temperature measured as in Example B1 was −10° C., the molecular weight in terms of styrene measured using THF as the solvent was 200000, and the acid number was 15 mg KOH/g.

### Comparative Example B10

In Comparative Example B10, an ink was produced and evaluated as in Example B7 except that the fluorine resin particle dispersion in Example B7 was not added.

The ink composition is shown in Table 10. The abrasion resistance test, the dry-cleaning test, and the discharge stability test were carried out as in Example B7. Table 9 shows the results.

### Comparative Example B11

In Comparative Example B11, an ink was produced and evaluated as in Example B8 except that the fluorine resin particle dispersion in Example B8 was not added.

The ink composition is shown in Table 10. The abrasion resistance test, the dry-cleaning test, and the discharge stability test were carried out as in Example B7. Table 9 shows the results.

### Comparative Example B12

In Comparative Example B12, an ink was produced and evaluated as in Example B9 except that the fluorine resin particle dispersion in Example B9 was not added.

The ink composition is shown in Table 10. The abrasion resistance test, the dry-cleaning test, and the discharge stability test were carried out as in Example B7. Table 9 shows the results.

### Comparative Example B13

In Comparative Example B13, an ink was produced and evaluated as in Example B10 except that the fluorine resin particle dispersion in Example B10 was not added.

The ink composition is shown in Table 10. The abrasion resistance test, the dry-cleaning test, and the discharge stability test were carried out as in Example B7. Table 9 shows the results.

### Comparative Example B14

### (1) Production of Pigment Dispersion B8

In pigment dispersion B8, pigment violet 19 (quinacridone pigment: manufactured by Clariant) was used. A reaction vessel equipped with a stirrer, a thermometer, a reflux tube, and a dropping funnel was substituted by nitrogen, and then 40 parts of benzyl acrylate, 10 parts of acrylic acid, 30 parts of butyl acrylate, and 0.3 parts of t-dodecyl mercaptan were put in the vessel, followed by heating to 70° C. Separately prepared 60 parts of benzyl acrylate, 37 parts of acrylic acid, 70 parts of butyl acrylate, 1 part of t-dodecyl mercaptan, 20 parts of methyl ethyl ketone, and 1 part of sodium persulfate were dropwise added to the reaction vessel through the dropping funnel over 4 hours, thereby polymerizing a dispersion polymer. Then, methyl ethyl ketone was added to the reaction vessel to produce a solution of dispersion polymer having a concentration of 40%. The dispersion polymer had a molecular weight, in terms of styrene, of 100000 when measured by gel permeation chromatography (GPC) with an L7100 system manufactured by Hitachi Ltd. using THF as the solvent. The constitutional ratios of the benzyl acrylate and the acrylic acid blended in the dispersion polymer were 40% by weight and 19% by weight, respectively.

Furthermore, 40 parts of the dispersion polymer solution, 30 parts of pigment violet 19 (quinacridone pigment: manufactured by Clariant), 100 parts of a 0.1 mol/L aqueous solution of sodium hydroxide, and 30 parts of methyl ethyl ketone were mixed and were then subjected to dispersion by 15 passes at 200 MPa using an ultrahigh-pressure homogenizer (ultimizer HJP-25005 manufactured by Sugino Machine Co., Ltd.). Then, the resulting dispersion was transferred to another vessel, and 300 parts of ion-exchanged water were added thereto, followed by further stirring for 1 hour. Thereafter, the whole amount of the methyl ethyl ketone and a part of the water were distilled using a rotary evaporator, followed by neutralization with 0.1 mol/L sodium hydroxide to adjust the pH to 9. Then, filtering through a 0.3 μm membrane filter and adjustment with ion-exchanged water were performed to give pigment dispersion B8 having a pigment concentration of 15%. The particle size measured by the same method as in Example B1 was 100 nm.

### (2) Preliminary Arrangement of Polymer Microparticle

The same polymer microparticle PU-B as in Example B10 was used as the polymer microparticles.

### (3) Preliminary Arrangement of Fluorine Resin Particle Dispersion B3

The same fluorine resin particle dispersion B3 as in Example B4 was used as the fluorine resin particles.

### (4) Preparation of Inkjet Recording Ink

An ink was produced as in Example B1 by mixing the above-mentioned pigment dispersion B8 and the fluorine resin particle dispersion B3 with the vehicle components shown in Table 10.

### (5) Abrasion Resistance Test and Dry-Cleaning Test

Evaluation was conducted as in Example B7 using the ink of Comparative Example B14. Table 9 shows the results of the abrasion resistance test and the dry-cleaning test.

### (6) Measurement of Discharge Stability

Evaluation was conducted as in Example B7 using the ink of Comparative Example B14. Table 9 shows the results.

### Reference Example B1

In Reference Example B1, an ink was produced and evaluated as in Example B7 except that the addition amount of the fluorine resin particles in Example B7 was less than 10% by weight of the pigment content.

The ink composition is shown in Table 10. The abrasion resistance test, the dry-cleaning test, and the discharge stability test were carried out as in Example 37. Table 9 shows the results.

### Reference Example B2

In Reference Example B2, an ink was produced and evaluated as in Example B7 except that the addition amount of the fluorine resin particles in Example B7 was larger than 150% by weight of the pigment content.

The ink composition is shown in Table 10. The abrasion resistance test, the dry-cleaning test, and the discharge stability test were carried out as in Example B7. Table 9 shows the results.

TABLE 9
Results of abrasion resistance, dry cleaning, and
discharge stability in Examples B7 to B10, Comparative
Examples B10 to B14, and Reference Examples B1 and B2

| | Par- | Abrasion | | | |
|---|---|---|---|---|---|
| | ticle | resistance | | | |
| | size | (reinforcement) | | Dry | Discharge |
| | (nm) | Dry | Wet | cleaning | stability |
| Example B7 | 80 | 4/5 | 4/5 | 4/5 | A |
| Example B8 | 80 | 4/5 | 4/5 | 4/5 | A |
| Example B9 | 90 | 5 | 4 | 5 | B |
| Example B10 | 90 | 5 | 4 | 4/5 | A |
| Comparative Example B10 | 80 | 2/3 | 3 | 4/5 | A |
| Comparative Example B11 | 80 | 2/3 | 3 | 4/5 | A |
| Comparative Example B12 | 90 | 3 | 2/3 | 5 | B |
| Comparative Example B13 | 90 | 3 | 2/3 | 4/5 | A |
| Comparative Example B14 | 100 | 2/3 | 2 | 2/3 | B |
| Reference Example B1 | 80 | 3/4 | 3/4 | 4/5 | A |
| Reference Example B2 | 80 | 5 | 4/5 | 4/5 | B |

Particle size: average particle size (nm) of pigment dispersion
Abrasion resistance and dry cleaning are based on evaluation standard of JIS.

TABLE 10
Ink compositions (% by weight) of Examples B7 to B10, Comparative Examples
B10 to B14, and Reference Examples B1 and B2

| | | | | | | | | | | Reference | |
|---|---|---|---|---|---|---|---|---|---|---|---|
| | Example | | | | Comparative Example | | | | | Example | |
| | B7 | B8 | B9 | B10 | B10 | B11 | B12 | B13 | B14 | B1 | B2 |
| Pigment dispersion B1 | 3.5 | 3.5 | — | — | 3.5 | 3.5 | — | — | — | 3.5 | 3.5 |
| Pigment dispersion B2 | — | — | 4.0 | 4.0 | — | — | 4.0 | 4.0 | — | — | — |
| Pigment dispersion B8 | — | — | — | — | — | — | — | — | 4.0 | — | — |
| EM-D | 3.5 | — | — | — | 3.5 | — | — | — | — | 3.5 | 3.5 |
| EM-E | — | 3.5 | — | — | — | 3.5 | — | — | — | — | — |
| PU-A | — | — | 3.5 | — | — | — | 3.5 | — | — | — | — |
| PU-B | — | — | — | 3.5 | — | — | — | 3.5 | 3.5 | — | — |
| Fluorine resin dispersion B3 | 2.0 | 2.0 | 2.0 | 2.0 | — | — | — | — | 2.0 | 0.3 | 6.0 |
| 1,2-HD | 3.0 | 3.0 | 3.0 | 3.0 | 3.0 | 3.0 | 3.0 | 3.0 | 3.0 | 3.0 | 3.0 |
| TEGmBE | 1.0 | 1.0 | 1.0 | 1.0 | 1.0 | 1.0 | 1.0 | 1.0 | 1.0 | 1.0 | 1.0 |
| S-104 | 0.3 | 0.3 | 0.3 | 0.3 | 0.3 | 0.3 | 0.3 | 0.3 | 0.3 | 0.3 | 0.3 |
| S-465 | 0.5 | 0.5 | 0.3 | 0.3 | 0.5 | 0.5 | 0.3 | 0.3 | 0.3 | 0.5 | 0.5 |
| S-61 | — | — | 0.2 | 0.2 | — | — | 0.2 | 0.2 | 0.2 | — | — |
| Glycerin | 10.0 | 10.0 | 9.0 | 9.0 | 12.0 | 12.0 | 11.0 | 11.0 | 9.0 | 12.0 | 4.0 |
| TMP | 3.0 | 3.0 | 3.0 | 3.0 | 3.0 | 3.0 | 3.0 | 3.0 | 3.0 | 3.0 | 3.0 |
| TEG | 5.0 | 5.0 | 4.0 | 4.0 | 5.0 | 5.0 | 4.0 | 4.0 | 4.0 | 5.0 | 5.0 |
| TEA | 1.0 | 1.0 | 1.0 | 1.0 | 1.0 | 1.0 | 1.0 | 1.0 | 1.0 | 1.0 | 1.0 |
| Ion-exchanged water | balance | balance | balance | balance | balance | balance | balance | balance | balance | balance | balance |

The ink composition (% by weight) of pigment dispersion shows solid content concentration of each pigment.
The ink composition (% by weight) of polymer microparticle shoes solid content concentration of each polymer microparticle.
The ink composition (% by weight) of fluorine resin particle dispersion shows fluorine resin particle concentration.
1,2-HD: 1,2-hexanediol
TEGmBE: triethylene glycol monobutyl ether
S-104: Surfynol 104 (acetylene glycol-based surfactant manufactured by Nissin Chemical Industry Co.)
S-465: Surfynol 465 (acetylene glycol-based surfactant manufactured by Nissin Chemical Industry Co.)
S-61: Surfynol 61 (acetylene alcohol-based surfactant manufactured by Nissin Chemical Industry Co.)
TMP: trimethylolpropane
TEG: triethylene glycol
TEA: triethanolamine

The invention has been described in detail with reference to specific embodiments, and it will be apparent to those skilled in the arts that various modifications and alterations can be made without departing from the spirit and the scope of the invention.

Furthermore, the present invention is based on Japanese Patent Applications (Patent Application Nos. 2009-011682 and 2009-011683) filed on Jan. 22, 2009 and Japanese Patent Applications (Patent Application Nos. 2010-000447 and 2010-000448) filed on Jan. 5, 2010, and the entire thereof are incorporated herein by reference. In addition, all the references cited herein are incorporated totally.

What is claimed is:

1. An inkjet recording ink comprising a pigment dispersion that enables a pigment to be dispersed in water by using a polymer in which 50% by weight or more of benzyl acrylate and 15% by weight or less of methacrylic acid and/or acrylic acid are polymerized as constituents and that has an average particle size of 50 nm or more and 300 nm or less; and fluorine resin particles having an average particle size of 400 nm or less.

2. An inkjet recording ink comprising a pigment dispersion that enables a pigment to be dispersed in water by using a polymer in which 50% by weight or more of benzyl acrylate and 15% by weight or less of methacrylic acid and/or acrylic acid are polymerized as constituents and that has an average particle size of 50 nm or more and 300 nm or less; polymer microparticles having a glass transition temperature of 0° C. or less and an acid number of 100 mg KOH/g or less; and fluorine resin particles having an average particle size of 400 nm or less.

3. The inkjet recording ink according to claim 2, wherein the polymer microparticles have a weight-average molecular weight, in terms of styrene, of 100000 or more and 1000000 or less when measured by gel permeation chromatography (GPC).

4. The inkjet recording ink according to any one of claims 1 to 3, wherein the pigment dispersion enables an organic pigment to be dispersed in water using the polymer and has an average particle size of 50 nm or more and 300 nm or less; and the polymer has a weight-average molecular weight, in terms of styrene, of 10000 or more and 200000 or less when measured by gel permeation chromatography (GPC).

5. The inkjet recording ink according to any one of claims 1 to 4, the ink further comprising 1,2-alkylene glycol.

6. The inkjet recording ink according to any one of claims 1 to 5, the ink further comprising an acetylene glycol-based surfactant and/or an acetylene alcohol-based surfactant.

7. The inkjet recording ink according to any one of claims 1 to 6, wherein the content of the fluorine resin particles is from 0.1 to 10% by weight.

8. The inkjet recording ink according to claim 7, wherein the content of the fluorine resin particles is from 10 to 150% by weight based on the pigment content.
